(19) United States
(12) Patent Application Publication
(10) Pub. No.: US 2016/0191188 A1
(43) Pub. Date: Jun. 30, 2016

(54) SYSTEM AND METHOD FOR LOCAL INTERCONNECTION OF OPTICAL NODES

(71) Applicant: Alcatel-Lucent USA Inc., Murray Hill, NJ (US)

(72) Inventor: David J. Butler, Richardson, TX (US)

(73) Assignee: ALCATEL-LUCENT USA INC., Murray Hill, NJ (US)

(21) Appl. No.: 14/587,164

(22) Filed: Dec. 31, 2014

(51) Int. Cl. H04J 14/02; H04Q 11/00

(52) U.S. Cl. CPC H04J 14/021; H04Q 11/0005

(57) ABSTRACT

A local interconnection carries one or more local interconnect optical channels between optical nodes at a site. The optical nodes include reconfigurable optical add-drop multiplexers (ROADMs). The local interconnect optical channels are switched by the ROADMs in the optical nodes for transmission over the local interconnection. In addition, modules within an optical node are operable to communicate using an LI optical channel that is switched over a local interconnection by a ROADM of the optical node.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not applicable.

### BACKGROUND

1. Technical Field

This disclosure relates generally to optical nodes and more particularly, but not exclusively, to systems and methods for local interconnections of modules within optical nodes.

2. Description of Related Art

The statements in this section provide a description of related art and are not admissions of prior art. Optical nodes offer high bandwidth capacity in long haul transport fibers or optical lines. However, deploying and operating optical nodes in an optical network often requires heavy manual involvement and on-site interventions. These manual interventions increase costs and time for deployment and reconfiguration of services.

Some optical nodes help to alleviate these problems by including a reconfigurable optical add drop multiplexer (ROADM). A ROADM allows remote configuration for adding or dropping of wavelengths from a long haul optical line rather than requiring a technician to manually configure specific wavelengths. For example, an operator using a network or element management system from a network operation center is able to provision services by configuring one or more optical channels to be added and/or dropped by a ROADM. Similarly, the network or element management system provides for remote configuration of optical channels that are passed through the ROADM from one long haul optical line to another, without a technician visit to the optical node site.

However, a problem still exists when it is necessary to interconnect one or more modules within an optical node or interconnect two local optical nodes at a site. Often large volumes of traffic need to be transported locally between shelves of a rack or between different physical racks or chassis of optical nodes. Local interconnections between optical nodes at a site currently requires manual involvement onsite to install short reach optical interfaces between shelves of a rack or between different physical racks or chassis incorporating optical nodes. These short reach optical interfaces are then manually connected by optical patch cords. The manual provisioning of such optical interfaces and patch cords between shelves of a rack or between different physical racks or chassis is prone to human error. In addition, these manually provisioned optical interfaces and patch cords are not remotely reconfigurable.

Optical nodes are evolving to include ROADMs with increasing degrees of switching. As these optical systems become more complex, the number of modules increases, e.g. to increase capacity and increase the number of degrees of switching. Physical space to include the increased number of modules may require local interconnection of two or more optical nodes in separate racks or separate physical chassis at a site.

A need thus exists for improved local interconnections between optical modules in an optical node or between optical nodes in separate physical racks of a chassis or in different chassis at a site.

### SUMMARY

In an embodiment, an optical node comprises a local interconnection including one or more optical fibers operably coupled to the optical node and another optical node at a same site and to a reconfigurable optical add/drop multiplexer (ROADM). The ROADM includes an add/drop module operable to generate a local interconnect optical channel and a photonic switch module that switches the local interconnect optical channel received from the add/drop module to the local interconnection for transmission to another optical node.

In another embodiment, an optical node comprises a first module operable to generate a first local signal, at least one add/drop module operable to receive the first local signal and generate a local interconnect optical channel in response to the first local signal, and a photonic switch module that receives the local interconnect optical channel from the add/drop module and switches the local interconnect optical channel back to the add/drop module. The add/drop module receives the local interconnect optical channel and generates a second local signal for transmission to a second module of the optical node.

In still another embodiment, an optical node comprises at least one add/drop module operable to receive a first local signal from a first module of the optical node and generate a local interconnect optical channel in response to the first local signal, and a photonic switch module that receives the local interconnect optical channel from the add/drop module and switches the local interconnect optical channel over a local interconnection back to the add/drop module, wherein the photonic switch module includes a set of wavelength selective switches operably coupled to the local interconnection.

In some embodiments of any of the above apparatus/methods, the optical node is operable to generate the local interconnect optical channel in an outer local interconnect band of wavelengths in a range of approximately 1566 to 1580 nm.

In some embodiments of any of the above apparatus/methods, the optical node includes at least one long haul optical line operably coupled to the reconfigurable optical add/drop multiplexer.

In some embodiments of any of the above apparatus/methods, the photonic switch module is further operable to switch one or more long haul optical channels received from the long haul optical line to the local interconnection for transmission to the another optical node.

In some embodiments of any of the above apparatus/methods, the photonic switch module includes a set of wavelength selective switches operably coupled to the long haul optical line and the local interconnection.

In some embodiments of any of the above apparatus/methods, the set of wavelength selective switches includes a first M×N wavelength selective switch operable to switch one or more optical channels received from S inputs to the long haul optical line and to switch the local interconnect optical channel received from one or more of the S inputs to the local interconnection.

In some embodiments of any of the above apparatus/methods, the set of wavelength selective switches includes a second M×N wavelength selective switch operable to switch the one or more long haul optical channels received from the one or more long haul optical lines to one or more of S outputs and to switch the local interconnect optical channel received from the local interconnection to one or more of the S outputs.

In some embodiments of any of the above apparatus/methods, the optical node includes a wavelength tracker system. The wavelength tracker system includes a wavelength encoder operable to encode the local interconnect optical channel with an optical key, and a plurality of wavelength decoders operable to decode the optical key encoded in the local interconnect optical channel to track a path of the local interconnect optical channel.

In some embodiments of any of the above apparatus/methods, the reconfigurable optical add/drop multiplexer is remotely reconfigurable by a network management system to configure the local interconnect optical channel.

### BRIEF DESCRIPTION OF THE SEVERAL VIEWS OF THE DRAWINGS

Some embodiments of apparatus and/or methods in accordance with embodiments of the disclosure are now described, by way of example only, and with reference to the accompanying drawings, in which:

FIG. 1 illustrates a schematic block diagram of an embodiment of a local interconnection in an optical node;

FIG. 2 illustrates a schematic block diagram of another embodiment of a local interconnection;

FIG. 3 illustrates a schematic block diagram of an embodiment of a reconfigurable optical add/drop multiplexer (ROADM) in an optical node;

FIG. 4 illustrates a schematic block diagram of another embodiment of a reconfigurable optical add/drop multiplexer (ROADM) in an optical node;

FIG. 5 illustrates a schematic block diagram of an embodiment of a local interconnection between optical nodes;

FIG. 6 illustrates a schematic block diagram of an embodiment of a local interconnection between optical nodes in more detail;

FIG. 7 illustrates a schematic block diagram of another embodiment of a local interconnection between optical nodes;

FIG. 8 illustrates a schematic block diagram of an embodiment of characteristics of LI optical channels and LH optical channels;

FIG. 9 illustrates a schematic block diagram of an embodiment of a wavelength tracker system in an optical node; and

FIG. 10 illustrates a schematic block diagram of an embodiment of a network management system.

### DETAILED DESCRIPTION

The description and drawings merely illustrate the principles of various embodiments. It will thus be appreciated that those skilled in the art will be able to devise various arrangements that, although not explicitly described or shown herein, embody the principles herein and in the claims and fall within the spirit and scope of the disclosure. Furthermore, all examples recited herein are principally intended expressly to be only for pedagogical purposes to aid the reader in understanding the principles of the embodiments and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass equivalents thereof.

Optical nodes are evolving to include ROADMs with increasing degrees of switching. As these optical systems become more complex, the number of modules increases, e.g. to increase capacity and increase the number of degrees of switching. Physical space to include the increased number of modules may require local interconnection of two or more modules of an optical node in separate racks or two or more optical nodes in separate physical chassis at a site. A need thus exists for improved local interconnections within an optical node and between optical nodes at a site. In an embodiment, to solve these and other problems, optical modules or nodes located in different physical racks or chassis at a site are interconnected using a local interconnection. ROADMs switch local interconnect optical channels across the local interconnection allowing for remote provisioning, configuration and reconfiguration of the local interconnect optical channels.

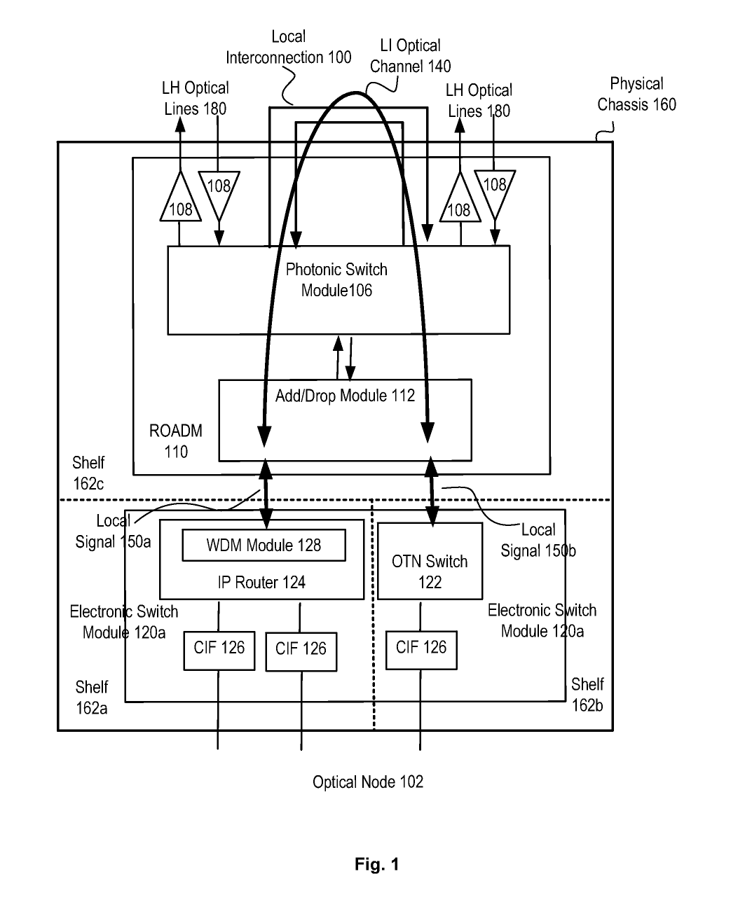

FIG. 1 illustrates an embodiment of a local interconnection 100 in an optical node 102. The optical node 102 includes a reconfigurable optical add-drop multiplexer (ROADM) 110. The ROADM 110 includes at least one add/drop module 112 and a photonic switch module 106 and a plurality of optical amplifiers 108. The photonic switch module 106 is operable to switch at least one local interconnect (LI) optical channel 140 over a local interconnection 100. The LI optical channel 140 refers to the optical signal or optical channel switched through the optical node over the local interconnection 100. The local interconnection 100 includes one or more optical fibers that carry the one or more LI optical channels 140. The LI optical channel 140 transmitted over local interconnection 100 is configurable and reconfigurable by ROADM 110 remotely and may be tracked and monitored remotely.

In an embodiment, optical node 102 further includes one or more electronic switch modules 120a and 120b. In an embodiment, one of the electronic switch modules 120b includes an optical transport network (OTN) switch 122 coupled to one or more client interfaces 126. ITU-T Recommendation G.709 “Interfaces for the Optical Transport Network”, dated February 2012, hereby incorporated by reference herein, describes OTN and an optical channel wrapper or frame structure for mapping various optical data units. OTN is designed to provide support for optical networking using DWDM. OTN signals can accommodate various formats or lines rates, including, e.g., SONET OC-48, OC-192, STM-64, 10 Gigabit Ethernet, 10 Fibre Channel, etc. OTN switch 122 is based on OTN and thus uses a packet switch type fabric. The OTN switch 122 performs grooming of the client interface signals and provides one or more local signals 150b to ROADM 110.

In addition to OTN switch 122, one of the electronic switch modules 120a includes an Internet protocol (IP) router 124. The IP router 124 performs grooming of electronic signals and provides the electronic signals to a WDM module 128 for electrical to optical conversion and multiplexing into one or more local signals 150a. The WDM module 128 may be included as part of the IP router 124 or be a separate module within optical node 102. The local signals 150a and 150b are provided to ROADM 110.

ROADM 110 has the advantage of configuration and reconfiguration of optical channels without unnecessary optical to electrical or electrical to optical conversions. Thus, in an embodiment, ROADM 110 includes multi-degree, colorless/directionless add/drop multiplexer technology. ROADM 110 includes photonic switch module 106 and optical amplifiers 108. The optical amplifiers 108 are coupled to long haul (LH) optical lines 180. The LH optical lines 180 carry optical signals between optical nodes at remote sites over metro or wide area networks.

In this embodiment, photonic switch module 106 switches LI optical channels 140 between different modules of optical node 102. For example, optical node 102 includes a plurality of modules mounted within a rack or physical chassis 160. In general, a physical chassis 160 physically encases the optical node 102 and includes a plurality of shelves 162. Various or different modules may be located on one or more of the plurality of shelves 162. The different types of modules include, e.g., ROADM 110, WDM module 128, IP router 124, OTN switch 122, optical amplifiers 108, optical protection switch module, etc. Modules located on different shelves 162 in a physical chassis 160 may be interconnected by one or more LI optical channels 140 switched through ROADM 110 in the optical node 102.

To connect modules on different shelves 162, one or more LI optical channels 140 are switched through photonic switch module 106 over local interconnection 100. For example, shown in FIG. 1, a first module, IP router 124, is located on a first shelf 162a of optical node 102 and a second module, OTN switch 122, is located on a second shelf 162b of optical node 102 while ROADM 110 is located on a third shelf 162c. In an embodiment, a first optical local signal 150a is generated by the first module, e.g. IP router 124. The first local signal 150a is transmitted to a first port of add/drop module 112 in ROADM 110. Add/drop module 112 switches the local signal 150a to at least one LI optical channel 140. Add/drop module 112a routes the LI optical channel 140 to photonic switch module 106. Photonic switch module 106 switches the LI optical channel 140 over local interconnection 100 back to add/drop module 112. Add/drop module 112 outputs a second local signal 150b in response to the LI optical channel 140 at a second port to a second module, e.g. OTN switch 122. Photonic switch module 106 is thus able to interconnect modules on different shelves 162 of a physical chassis 160 by switching one or more LI optical channels 140 through the photonic switch module 106.

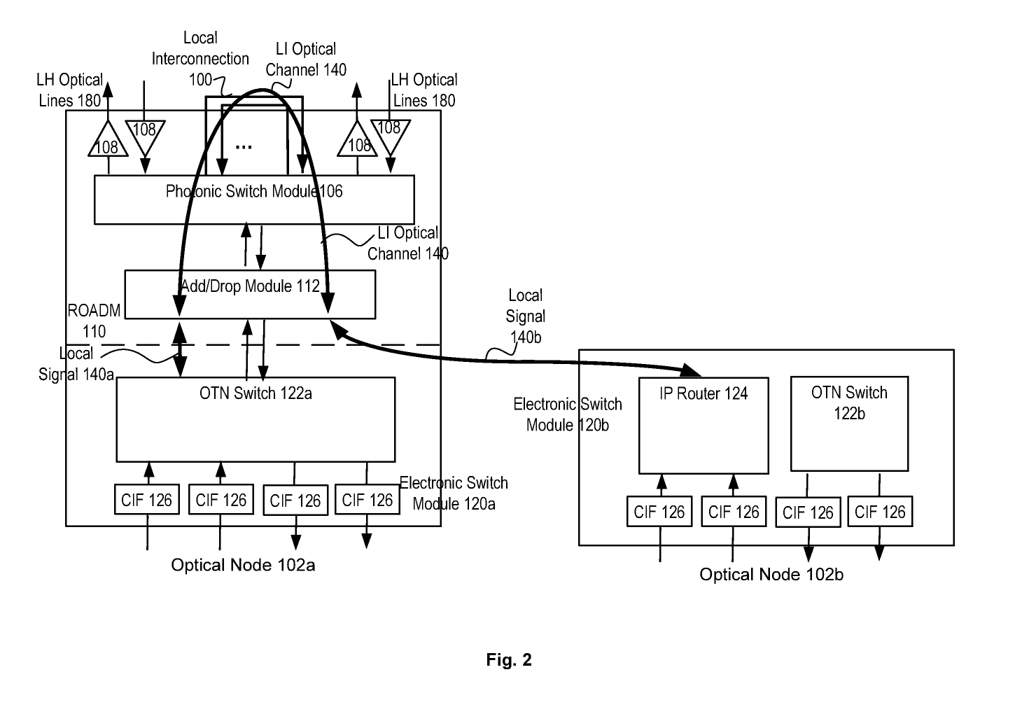

FIG. 2 illustrates another embodiment of a local interconnection 100 between two optical nodes 102a and 102b. In this embodiment, modules in optical node 102a (such as OTN switch 122a) communicate with modules in optical node 102b (such as IP router 124 and OTN switch 122b) using LI optical channels 140 switched over local interconnection 100 in ROADM 110. For example, a local signal 140b from IP router 202 in optical node 102b is input to add/drop module 112. Add/drop module 112 generates a LI optical channel 140 and transmits the LI optical channel 140 to photonic switch module 106. The photonic switch module 106 switches the LI optical channel 140 over local interconnection 100 back to the add/drop module 112. The add/drop module 112 outputs a local signal 140a to OTN switch 122a. The IP router 124 in optical node 102b and OTN switch 122a in optical node 102a are thus operable to communicate using ROADM 110 of optical node 102a.

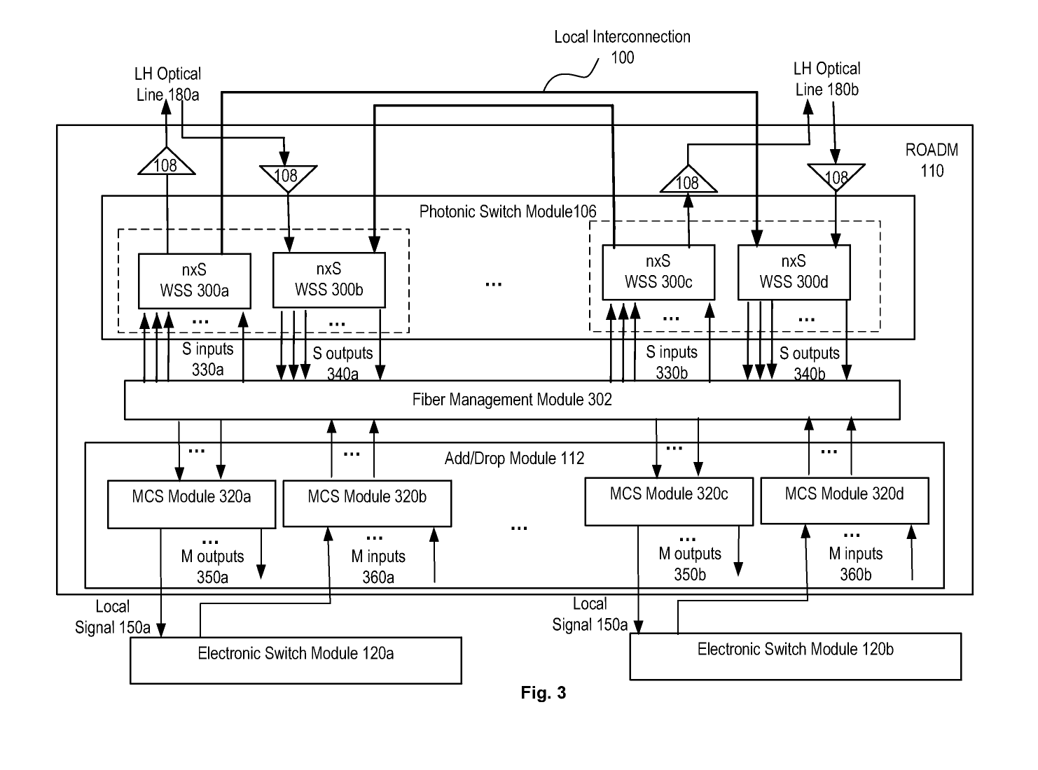

FIG. 3 illustrates an embodiment of ROADM 110 in an optical node 102. In the embodiment of FIG. 3, ROADM 110 includes photonic switch module 106, fiber management module 302 and add/drop module 112. In other embodiments, ROADM 110 may have other degrees of switching and other add/drop modules 112 in addition to those shown in FIG. 3. In an embodiment, photonic switch module 106 in ROADM 110 includes a plurality of wavelength selective switch (WSS) modules 300a-d. The WSS modules 300 are operable to perform M×N switching using one or more of a plurality of types of switching technologies, such as microelectromechanical systems (MEMS), liquid crystal, thermo optic and beam-steering switches in planar waveguide circuits, and tunable optical filter technology. The plurality of WSS modules 300a-d are operably coupled to add/drop module 112 through mesh connections in fiber management module 302 that provides a broadcast and select architecture. However, other implementations and architectures of a ROADM that include alternative or additional or less components operable to perform photonic switching may also be used in one or more embodiments herein.

The photonic switch module 106 includes S inputs 330a and 330b, and S outputs 340a and 340b. In an embodiment herein, at least two sets of WSS modules 300 are operable to perform n×S switching, wherein n is equal to or greater than 2. In an embodiment, a first set of WSS modules 300a and 300b includes an add 2×S WSS module 300a and a drop 2×S WSS module 300b. The add 2×S WSS module 300a is operable to switch optical channels received at the S inputs 330a to long haul (LH) optical line 180a and to switch local interconnect optical channels 140 received at the S inputs 330a to local interconnection 100. The drop 2×S WSS module 300b is operable to switch one or more optical channels received over the LH optical line 180a to the S outputs 340a and to switch LI optical channels 140 received from local interconnection 100 to the S outputs 340a. Other optical channels received over the LH optical line 180a may be passed through and not dropped.

Similarly, in an embodiment, a second set of WSS modules 300c and 300d includes an add 2×S WSS module 300c and a drop 2×S WSS module 300d. The add 2×S WSS module 300c is operable to switch optical channels received at S inputs 330b to LH optical line 180b or to switch LI optical channels 140 to local interconnection 100. The drop 2×S WSS module 300b is operable to switch one or more optical channels received over the LH optical line 180b to S outputs 340b and to switch LI optical channels received over local interconnection 100 to S outputs 340b. Other optical channels received over the LH optical line 180b may be passed through and not dropped.

By employing at least two sets of n×S WSS modules 300, wherein n is equal to or greater than 2, the photonic switch module 106 is operable to provide bi-directional transmission of local interconnect optical channels 140 over local interconnection 100. Though only two sets of WSS modules 300 are shown with two LH optical lines 180, additional sets of WSS modules may be employed to increase the degrees of switching over additional LH optical lines 180. These WSS modules may be 1×S modules if switching to LH optical lines 180 and not to a local interconnection 100 or other outputs as described further herein or may include additional n×S modules if switching to other outputs.

Add/drop module 112 includes a plurality of multi-cast switch (MCS) modules 320. In an embodiment, MCS modules 320 are operable to perform colorless, any direction, contentionless (CDC) add/drop functionality for M inputs 360 or M outputs 350. For example, a local signal 150, e.g. such as a 100G or 200G uplink, from an electronic switch module 120 is received at one of the M inputs 360a at MCS module 320b or M inputs 360b at MCS module 320d. MCS modules 320b and/or 320d are operable to switch the local signal 150 to an optical channel to the fiber management module 302. In addition, MCS modules 320a and 320c are operable to receive an optical channel from one or more of the LH optical lines 180b or local interconnection 100 and to switch it for dropping to one of their respective M outputs 350a or 350b, shown as local signal 150a or 150b. An MCS module 302 is also operable to carry without interference multiple WDM carriers of the same color/wavelength that are being switched to different of the N degrees, providing “contentionless” throughput. In an embodiment, an amplifier array (not shown) is employed with the MCS modules 320 on connections to the WSS modules 300 in order to boost signals thereon.

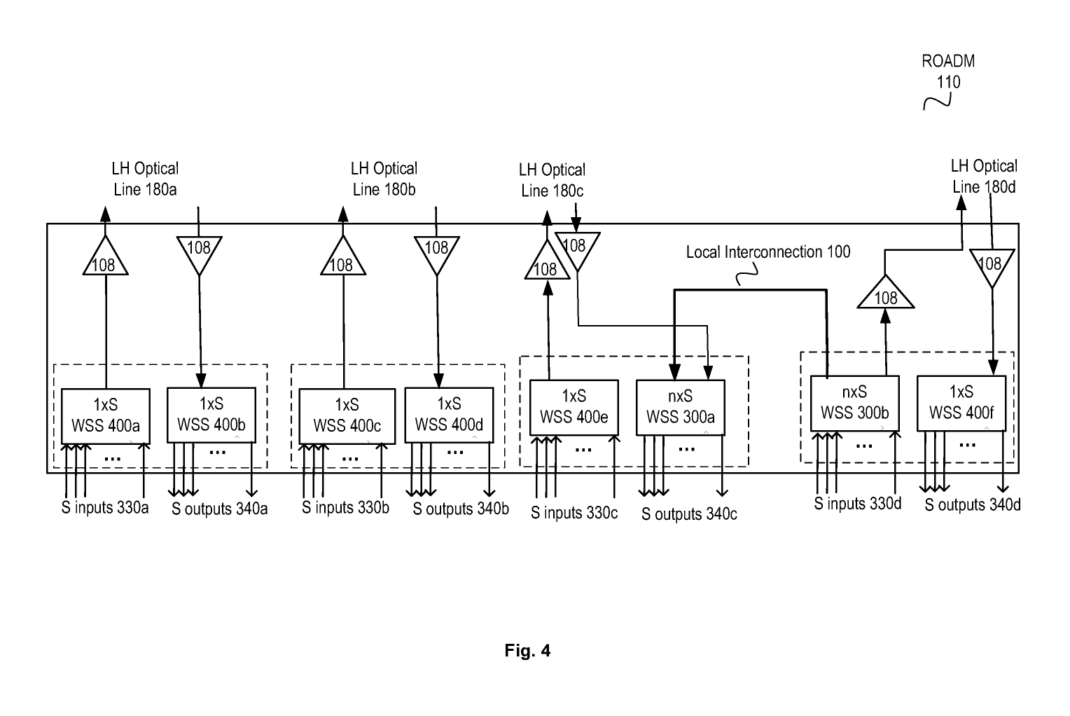

FIG. 4 illustrates another embodiment of local interconnection 100 in ROADM 110 in an optical node 102. ROADM 110 includes N degrees of switching over LH optical lines 180, wherein N=4 in this figure. Other degrees of switching may also be employed as well. In an embodiment, ROADM 110 includes one or more sets of 1×S WSS modules 400. WSS modules 400a and 400c include add 1×S switches that are operable to switch optical channels at S inputs 330a and 330b to LH optical lines 180a and 180b respectively, but not to a local interconnection 100. Similarly, WSS modules 400b and 400d include drop 1×S switches that are operable to switch optical channels received from LH optical lines 180a and 180b to one or more of the S outputs 340a and 340b respectively.

In this embodiment, one WSS module 300 in at least two sets of WSS modules are operable to perform n×S switching to the local interconnection 100, wherein n is equal to or greater than 2. For example, WSS module 300a in a first set of WSS modules 400e and 300a is a 2×S switch operable to receive optical channels over local interconnection 100 as well as LH optical line 180c. Another 2×S WSS module 300b is included in a second set of WSS modules 300b and 400f. The 2×S WSS module 300b is operable to switch optical channels over local interconnection 100 as well as LH optical line 180d. In this embodiment, local interconnection 100 is used to communicate between modules of an optical node 102 using an add 2×S WSS module in a first set of WSS modules and a drop 2×S WSS module in a second set of WSS modules.

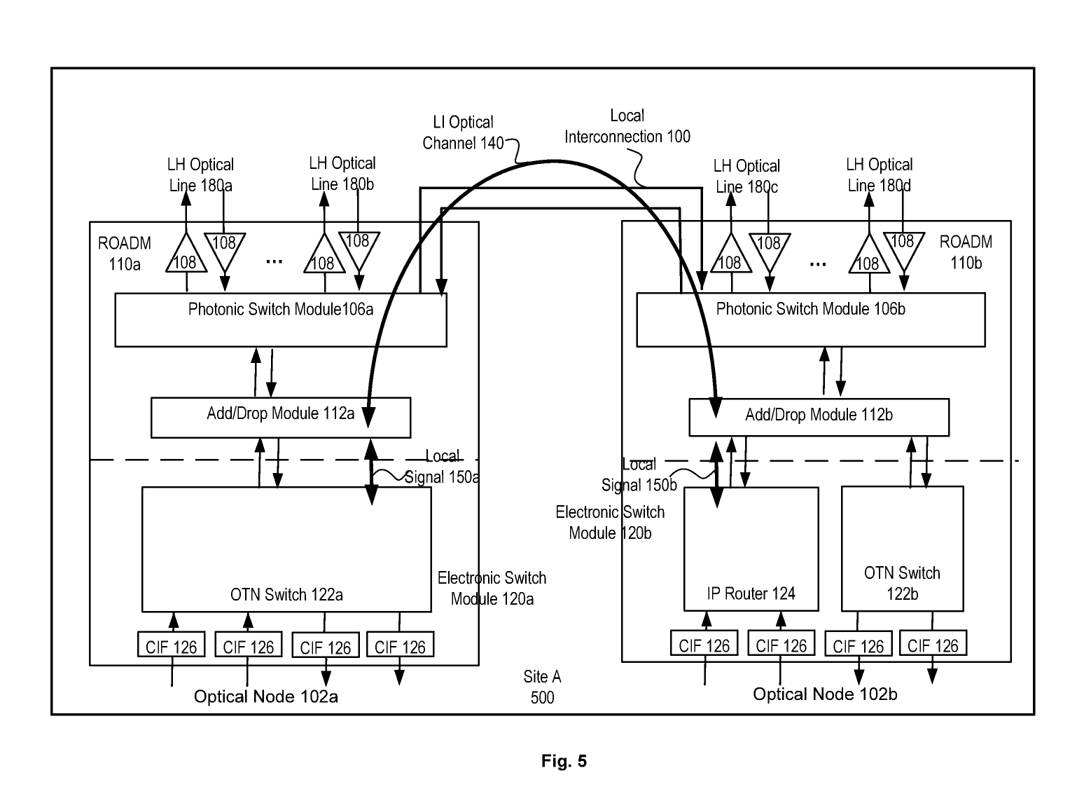

FIG. 5 illustrates an embodiment of transmission of LI optical channel 140 over local interconnection 100 between optical nodes 102a and 102b at a same site. In an embodiment, local interconnection 100 connects ROADMs 110a and 110b in optical nodes 102a and 102b that are located in a same site, e.g. Site A 500. For example, Site A 500 is a same physical location, such as a building, enterprise, data center, warehouse, etc., wherein the local interconnection 100 between optical nodes 102a and 102b is 10 km or less. In an embodiment wherein optical nodes 102a and 102b are located in adjacent racks or otherwise in close proximity at Site A 500, local interconnection is 10 meters or less. In contrast, LH optical lines 180 carry optical signals to optical nodes at remote sites over metro or wide area networks that are generally at distances of at least 40-100 km.

For example, one or more of the modules of optical node 102a, e.g. electronic switch module 120a, generates a first local signal 150a and transmits the local signal 150a to add/drop module 112a. Add/drop module 112a receives the local signal 150a and generates at least one LI optical channel 140 in response thereto. Add/drop module 112a routes the LI optical channel 140 to photonic switch module 106a. The photonic switch module 106a receives the LI optical channel 140 and switches the LI optical channel 140 to local interconnection 100. In an embodiment, local interconnection 100 includes at least two optical fibers, one for each direction of transmission between the optical nodes 102a and 102b. In another embodiment, bi-directional transmission over a single optical fiber of local interconnection 100 may be employed.

ROADM 110b in optical node 102b receives the one or more LI optical channels 140 from local interconnection 100. Photonic switch module 106b in optical node 102b switches the at least one LI optical channels 140 to add/drop modules 112b. Add/drop module 112 switches the LI optical channel 140 to one or more of its egress drop ports and generates a local signal 150b to electronic switch module 102b. The local signal 150b is thus transmitted to IP router 124. The LI optical channel 140 is thus switched through ROADMs 110a and 110b over local interconnection 100. The local interconnection 100 is thus able to connect optical nodes 102a and 102b that are located in a same site.

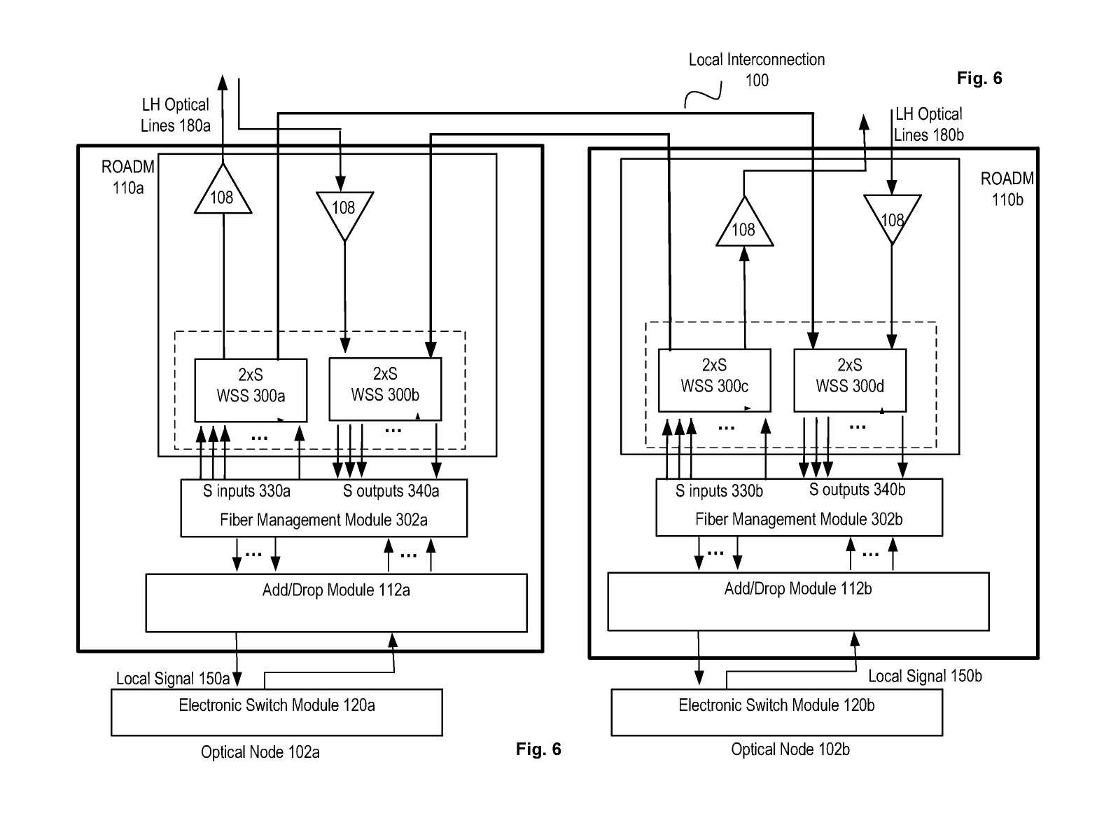

FIG. 6 illustrates an embodiment of local interconnection 100 between two optical nodes 102a and 102b in more detail. In an embodiment herein, a first set of n×S WSS modules 300a and 300b is included in optical node 102a and a second set of n×S WSS modules 300c and 300d is included in optical node 102b.

The first set of WSS modules in optical node 102a includes an add n×S WSS module 300a and a drop n×S WSS module 300b, wherein n is equal to or greater than 2. In an embodiment, an add 2×S WSS module 300a is operable to switch optical channels received at S inputs 330a to at least two outputs, either LH optical line 180a or to local interconnection 100. A drop 2×S WSS module 300b is operable to switch one or more optical channels received from at least two inputs, e.g. the LH optical line 180a and local interconnection 100, to S outputs 340a. Other optical channels received over the LH optical line 180a may be passed through and not dropped.

Similarly, a second set of WSS modules 300c and 300d in optical node 102b includes an add 2×S WSS module 300c and a drop 2×S WSS module 300d. The add 2×S WSS module 300c is operable to switch optical channels received at S inputs 330b to either LH optical line 180b or to local interconnection 100. The drop 2×S WSS module 300b is operable to switch one or more optical channels received over the LH optical line 180b and local interconnection 100 to S outputs 340b. Other optical channels received over the LH optical line 180b may be passed through and not dropped. Though only two sets of WSS modules 300 are shown with two LH optical lines 180, additional sets of WSS modules may be employed to increase the degrees of switching over additional LH optical lines 180 in the optical nodes. By employing sets of 2×S WSS modules 300 in ROADMs 110a and 110b, optical nodes 102a and 102b are operable to switch optical channels over local interconnection 100 as well as LH optical lines 180a and 180b.

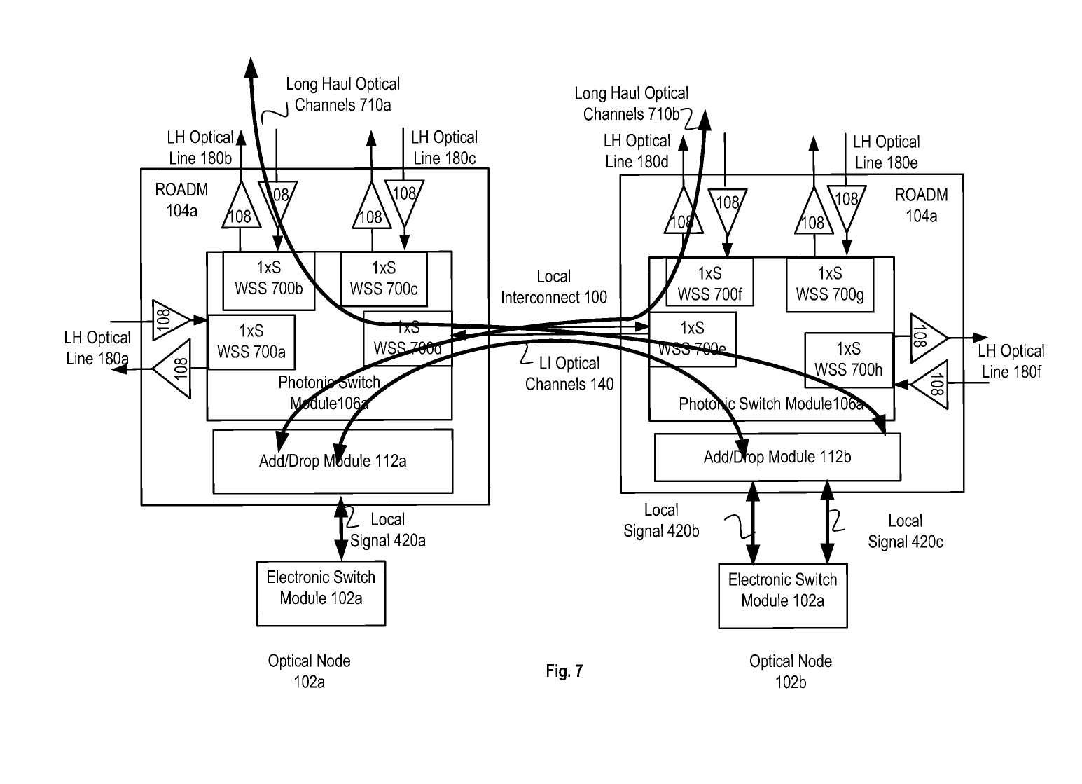

FIG. 7 illustrates another embodiment of local interconnection 100. In an embodiment, optical nodes 102a and 102b include local interconnection 100 as one of the multi-degree switching options in their respective ROADMs 110a and 110b. Local interconnection 100 connects optical nodes 102 that are located in a same site, e.g. located in a same physical location, such as in a same building, enterprise, data center, warehouse, etc. wherein the local interconnection 100 between optical nodes 102a and 102b is 10 km or less. In an embodiment wherein optical node 102a and 102b are located in adjacent racks or otherwise in close proximity at Site B, local interconnection is 10 meters or less. In contrast, the LH optical fibers 180 that carry optical signals between optical nodes at remote sites over metro or wide area networks are generally at distances of at least 40-100 km.

In this embodiment, a set of 1×S WSS modules 700a-h are employed for each degree of switching in the photonic switch modules 106a and 106b. One of the set of 1×S WSS modules 700d is operably coupled to local interconnection 100 in optical node 102a. In optical node 102b, one of the set of WSS modules 700e is operably coupled to local interconnection 100. The photonic switch modules 106a and 106b are thus operable to switch wavelengths to and from local interconnection 100.

In addition, in an embodiment, photonic switch module 106 is operable to switch ingress long haul (LH) optical channels 710, such as LH optical channel 710a, from one or more LH optical lines 180 to local interconnection 100 or to switch ingress LH optical channels 710 from local interconnection 100 to one or more of the outgoing LH optical lines 180, such as long haul optical channel 710b. LH optical channels 710 include optical signals or channels that are transmitted over the LH optical lines 180 between optical nodes 102 at remote site. For example, LH optical channels 710 travel over LH optical lines 180 between nodes that are generally at distances of at least 40-100 km.

In addition, the photonic switch modules 106a and 106b are operable to switch LI optical channels 140 between optical nodes 102a and 102b. As such, in an embodiment, local interconnection 100 is operable to carry both LH optical channels 710 to/from one or more of the LH optical lines 180 and LI optical channels 140. In another embodiment, photonic switch module 106 only switches LI optical channels 140 over local interconnection 100.

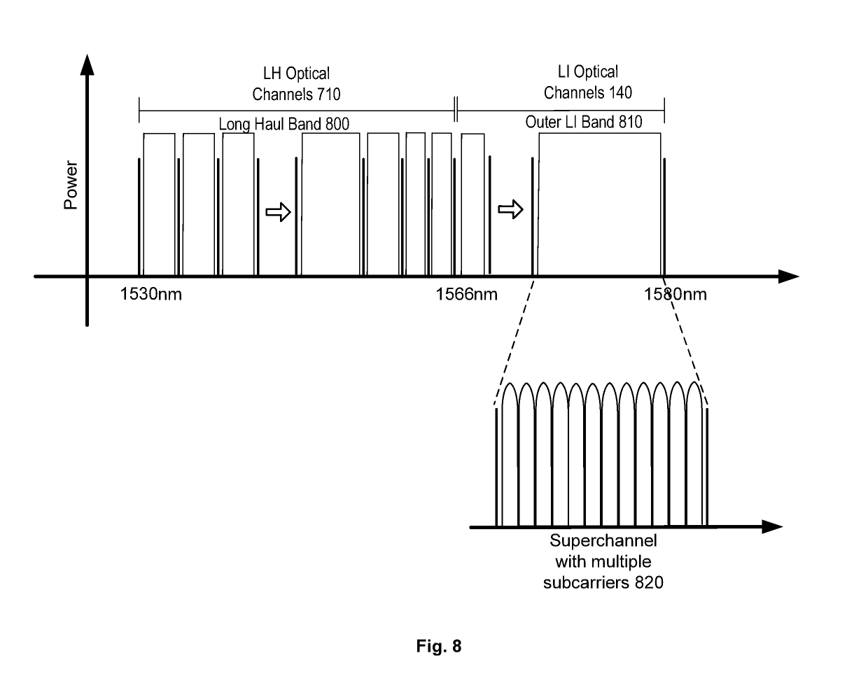

FIG. 8 illustrates an embodiment of characteristics of LI optical channels 140 and LH optical channels 710. In an embodiment, LH optical channels 710 are transmitted in long haul band 800 while LI optical channels 140 are transmitted in an outer LI band 810 outside of the range of the long haul band 800. For example, ITU-T G.694.1, “Spectral grids for WDM applications: DWDM frequency grid” dated February 2012 and incorporated by reference herein, describes a 50 GHz channel grid of optical channels in a standard C-band 600 from approximately 1530.0413 to 1553.6307 nm wavelengths or in terms of frequency from approximately 195.9375 to 192.9625 THz. The C-band and sometimes an extended C-band and L-band are often used for transmission of LH optical channels 710. To conserve these bands for the LH optical channels 710, LI optical channels 140 are transmitted in an outer LI band 810 at the outer edges of the range of the long haul band 800.

Since the LI optical channels 140 are traveling a relatively short distance between optical nodes 102 at a same site or between modules of an optical node 102, the LI optical channel signals do not need to be optimized for long distances. The transmission performance of amplifiers or other optical components in the local interconnection path is not critical as well. The LI optical channels 140 can therefore be placed in a part of the optical spectrum which is not used by the long haul optical channels 710, e.g. at an outer edge of the long haul band 800 used by the long haul optical channels 710. For example, if the long haul optical channels 710 are transmitted in a long haul band 800 that includes an extended C band in a range of approximately 1530 nm to approximately 1565 nm than the LI optical channels 140 may be transmitted in an outer LI band 810 in a range from approximately 1566 to approximately 1580 nm.

In an embodiment, the LI optical channels 140 and the long haul LI optical channels 710 may employ a flexible grid and channel bandwidth. For example, ITU-T G.694.1, “Spectral grids for WDM applications: DWDM frequency grid” (Edition 2), dated February 2012 and incorporated herein by reference defines a flexible DWDM grid within the standard C-band. The allowed frequency slots have a nominal central frequency (in THz) defined by: 193.1+n×0.00625 where n is a positive or negative integer including 0 and 0.00625 is the nominal central frequency granularity in THz. A channel bandwidth is defined by: 12.5×m where m is a positive integer and 12.5 is the channel bandwidth granularity in GHz. Any combination of frequency slots is allowed as long as no two frequency slots overlap. The use of a flexible grid and variable channel bandwidth may also be employed for the LI optical channels 140 within the outer LI band 810. In this embodiment, the optical nodes 102 employ flexible-grid ROADMs 110 that are operable to switch any amount of optical spectrum in increments of 12.5 GHz.

The variable channel bandwidth allows for use of one or more superchannels 820 in which one or multiple coherent carriers are digitally combined on a single line card to create an aggregate channel of a higher data rate. A super-channel 820 is switched and multiplexed/demultiplexed as an integral whole to eliminate guard bands between the internal sub-carriers of the super-channel. Guard bands are only required at the lower and upper edges of the super-channel itself. A super-channel and its constituent sub carriers are provisioned, transported and switched across the network as a single entity, and hence require the ROADMs 110 to support variable bandwidth switching, e.g. in multiples of 12.5 GHz, for super-channels of variable bandwidth. FIG. 8 illustrates an example of a flexible grid and variable channel bandwidth including super-channels 820 that may be employed by the LI optical channels 140 in the outer LI band 810.

Moreover, since the LI optical channels 140 travel relatively short distances, a higher spectral efficiency may be employed for the LI optical channels 140 than with the LH optical channels 710. For example, one method of achieving a higher spectral efficiency is using a higher order modulation format for the LI optical channels 140 than for the LH optical channels 710. In an embodiment, LH optical channels 710 are generally modulated at 3 and 4 bits per symbol, such as using QPSK in a dual polarization mode. Though higher order modulation is more spectrally efficient, its reach is shorter.

In an embodiment, the LI optical channels 140 are modulated at higher order modulation formats than the LH optical channels 710 to obtain a higher spectral efficiency. For example, dual polarization mode with a higher order modulation format, such as 64 QAM per polarization, results in 12 bits per symbol. In general, the higher order modulation formats used for LI optical channels 410 have greater than 4 bits per symbol while the modulation formats used for the LH optical channels 710 have 4 or less bits per symbol. Thus, a higher order modulation format has greater than 4 bits per symbol. Uusing higher order modulation formats increases the spectral efficiency of the LI optical channels 140 over the LH optical channels 710.

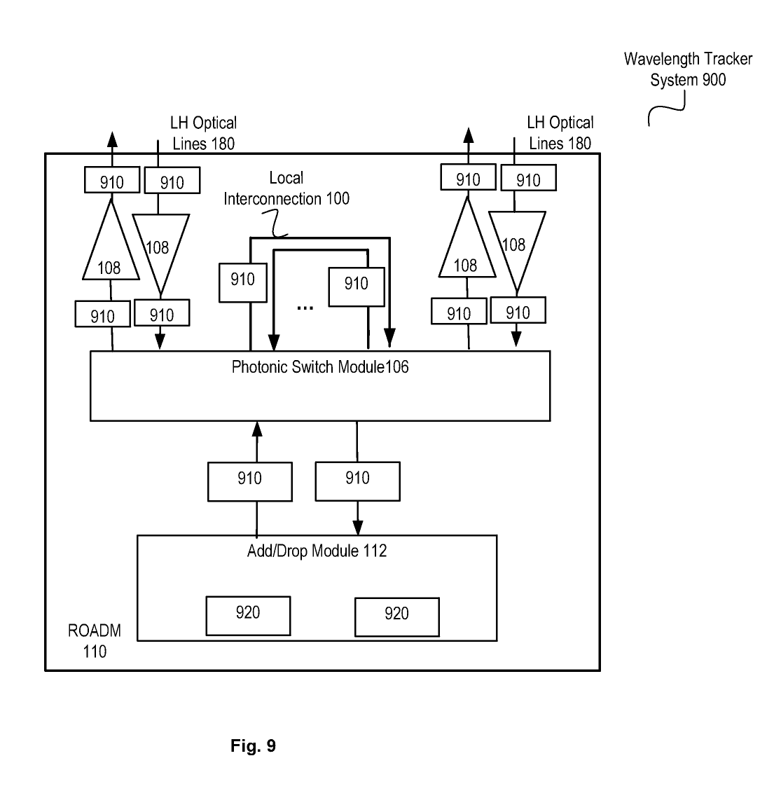

FIG. 9 illustrates an embodiment of a wavelength tracker system 900 in an optical node 102. One of the advantages of routing LI optical channels 140 through the ROADM 110 of an optical node 102 is that wavelength tracker system 900 is operable to monitor the LI optical channels 140. The wavelength tracker system 900 enables end-to-end power control, monitoring, tracing and fault localization for individual optical channels. The wavelength tracker system includes a plurality of wavelength tracker (WT) encoders 920 located in transponders of the add/drop module 112 or other module operable to generate the LI optical channels 140 and WT decoders 910 located at various points of the optical node 102. The WT decoders 910 may also be deployed on long-haul optical lines 180.

In an embodiment, a WT encoder 920 encodes a unique optical key into optical channels, including the LI optical channel 140, at the transponder level. The unique optical key encoded in an optical channel is decoded at various points in the optical node 102 by the WT decoders 910. The WT decoders 910 decode the optical key to identify the associated optical channel and also provide the optical power level for the optical channel, allowing complete optical layer visibility for network fiber connectivity and faults at multiple points in the optical node 102, regardless of whether the optical channel is added, dropped, or simply passed through. Wavelength tracker system 900 is operable to trace an end-to-end path of the optical channel and distinguish the optical channel from other optical channels—even multiple instances of the same wavelength in optical channels when wavelength reuse is erroneously employed in an optical node 102 or network.

Wavelength tracker system 900 also helps to automate power management in optical node 102. Target optical power levels are calculated for critical points in the system. Actual per-channel optical power is measured by WT decoders 910 at various points in the optical node 102. Based on the optical power measurements, feedback is provided to control power of an optical channel at its originating transponder and/or at the corresponding MCS module 320. In general, a variable optical attenuator (VOA) is employed to control power of the optical channel at the MCS modules 320 while WSS modules 300 employ power control as part of the optical switching fabric. This automated power management is a process that operates continuously to maintain optical power levels of an optical channel at desired thresholds and minimize optical power divergence of the optical channel throughout the optical node 102 and network. The result is automated power management when adding or removing wavelengths.

For example, in an embodiment, both LH optical channels 710 and LI optical channels 140 are switched by WSS modules 300. Thus, relative power of the LH optical channels 710 and LI optical channels 140 needs to be approximately the same or within an operational threshold. The wavelength tracker system 900 monitors the relative power levels of the LI optical channels 140 and the one or more LH optical channels 710. It also maintains relative power levels within operational thresholds, e.g. deviation thresholds must remain within the operational thresholds. For example, output power for one or more MCS modules 320 that outputs the LI optical channels 140 may be adjusted. Or the power of one or more LH optical channels 710 may be adjusted through the WSS modules 300 switching the LH optical channels 710 to the local interconnection 100.

The LI optical channels 140 routed through the ROADM 110 of an optical node 102 are thus monitored by the wavelength tracker system 900 providing end-to-end power control, monitoring, tracing and fault localization for the LI optical channels 140. The wavelength tracker system 900 helps enable remote provisioning and reconfiguring of the LI optical channels 140 without manual intervention.

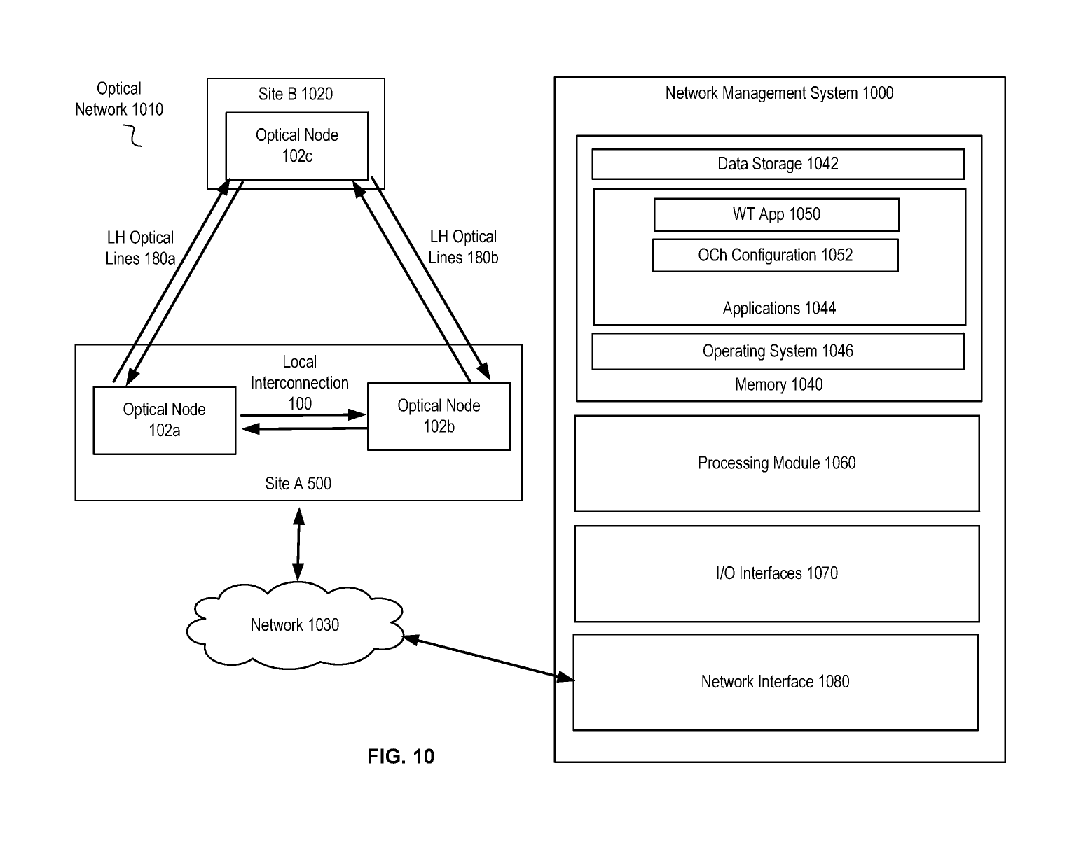

FIG. 10 illustrates an embodiment of a network management system 1000. The network management system 1000 is operably connected to optical network 1010 through network 1030. The optical network 1010 includes optical node 102a and optical node 102b located at a same Site A 500. Optical node 102a and 102b are operably connected by local interconnection 100 at Site A 500. The optical network 1010 further includes optical node 102c located at a remote Site B 1020 and operably connected to optical nodes 102a and 102b by LH optical lines 180a and 180b. Optical network 1010 may be a wide area network, metro network or mobile backhaul network. Site A and Site B are remotely located from each other at distances of typically at least 40-100 km. Site A is a same physical location, such as a building, enterprise, data center, warehouse, etc. wherein the local interconnection 100 between optical nodes 102a and 102b is 10 km or less. In an embodiment, optical node 102a and 102b are located in adjacent racks or otherwise in close proximity at Site A wherein the local interconnection is 10 meters or less. So a local interconnect includes an optical path between modules in an optical node 102 or between optical nodes 102 that is 10 km or less while a long haul includes an optical path between optical nodes 102 over a wide area network, metro network or mobile backhaul network that is at least 40-100 km.

Network management system 1000 includes a memory 1040, processing module 1060, I/O interfaces 1070 and network interface 1080. The network interface 1080 is operable to transmit and receive communications between the network management system 1000 and the optical nodes 102a, 102b and 102c. Network interface 1080 may be coupled to one or more of the optical nodes 102 over network 1030. Network 1030 includes one or more of a local area network (LAN), metro area network (MAN) or wide area network (WAN) or a combination thereof.

Network management system 1000 also includes I/O interfaces 1070. I/O interfaces 1070 include one or more devices for receiving data from and outputting data to one or more network operators. I/O interfaces 1070 may include a display, keyboard, mouse, touchscreen, etc. Network management system 1000 further includes processing module 1060 and memory 1040. Memory 1040 includes data storage 1042, applications 1044 and operating system 1046. Applications 1044 include, e.g., wavelength tracker system application (WT App) 1050 for operating wavelength tracker system 900. Wavelength tracker system application 1050 is operable to identify wavelengths in a wavelength channel, display the end-to-end path of an optical channel, including LI optical channels 140, in optical network 1010 and to distinguish optical channels from other optical channels. Wavelength tracker system application 1050 also provides power management of optical channels in optical network 1010.

In an embodiment, network management system 1000 also includes an optical channel (OCh) configuration application (OCh Configuration) 1052. The OCh configuration applications 1052 allows a network operator to remotely provision, configure and reconfigure optical channels, including LI optical channels 140, in optical nodes 102 in optical network 1010.

For example, OCh configuration application 1052 provides a procedure for network operators to remotely provision a new LI optical channel 140 between a first optical node 102a and a second optical node 102b that is switched between ROADMs 110 in the optical nodes 102a and 102b and transmitted over local interconnection 100. Once provisioned, wavelength tracker system application 1050 will automate power transmission of the new LI optical channel 140 and track the LI optical channel 140 through the optical nodes 102a and 102b. The LI optical channels 140 are thus configurable and reconfigurable remotely and may be tracked and monitored remotely.

In one or more embodiments described herein, optical nodes 102 located in different physical racks or chassis at a same site are operable to communicate using LI optical channels 140 transmitted over a local interconnection 100. ROADMs 104 at each of the nodes 102 switch LI optical channels 140 across the local interconnection allowing for remote provisioning, configuration and reconfiguration of the local interconnect optical channels 400. In another embodiment, modules within an optical node 102 are operable to communicate using LI optical channels 140 switched over a local interconnection 100 by a ROADM 110 of the optical node 102.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of functions, components, power connections, input(s), output(s), etc., to perform, when activated, one or more its corresponding functions and may further include direct or inferred coupling to one or more other items. As may still further be used herein, the term “associated with”, includes direct and/or indirect association or origination or coupling of separate items and/or one item being embedded within another item.

The term “module” is used in the description of the various embodiments of the disclosure. A “module” indicates a device that includes one or more hardware components, such as a single processing device or a plurality of processing devices. A module may also include software stored on memory for performing one or more functions as may be described herein. Note that, the hardware components of a module may operate independently and/or in conjunction with software and/or firmware. As used herein, a module may contain one or more sub-modules, each of which may be one or more modules. As may also be used herein, a module may include one or more additional components.

The description and figures includes functional building blocks. The boundaries and sequence of these functional building blocks may have been arbitrarily defined herein for convenience of description. Alternate boundaries and sequences can be defined so long as the specified functions and relationships are appropriately performed. Any such alternate boundaries or sequences are thus within the scope and spirit of the claimed invention. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The disclosure may have also been described, at least in part, in terms of one or more embodiments. An embodiment of the disclosure is used herein to illustrate the disclosure, an aspect thereof, a feature thereof, a concept thereof, and/or an example thereof. A physical embodiment of an apparatus, an article of manufacture, a machine, and/or of a process that embodies the disclosure may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the disclosure have been expressly described herein, other combinations of these features and functions are likewise possible. The disclosure is not limited by the particular examples disclosed herein and expressly incorporates these other combinations.

What is claimed is:

1. An optical node, comprising:
a local interconnection including one or more optical fibers operably coupled to the optical node and another optical node at a same site;
a reconfigurable optical add/drop multiplexer (ROADM), including:
at least one add/drop module operable to generate a local interconnect (LI) optical channel; and
a photonic switch module that switches the LI optical channel received from the at least one add/drop module to the local interconnection for transmission to the another optical node.

2. The optical node of claim 1, wherein the optical node further comprises:
at least one long haul (LH) optical line operably coupled to the reconfigurable optical add/drop multiplexer.

3. The optical node of claim 2, wherein the photonic switch module includes:
a set of wavelength selective switches operably coupled to the at least one LH optical line and the local interconnection.

4. The optical node of claim 3, wherein the set of wavelength selective switches includes a first n×S wavelength selective switch operable to switch one or more optical channels received from S inputs to the at least one LH optical line and to switch the LI optical channel received from one or more of the S inputs to the local interconnection, wherein n is equal to or greater than 2.

5. The optical node of claim 4, wherein the set of wavelength selective switches includes a second n×S wavelength selective switch operable to switch one or more LH optical channels received from the at least one LH optical line to one or more of S outputs and to switch the LI optical channel received from the local interconnection to one or more of the S outputs, wherein n is equal to or greater than 2.

6. The optical node of claim 1, wherein the LI optical channel is in an outer local interconnect band of wavelengths.

7. The optical node of claim 1, further comprising:
a wavelength tracking system, wherein the wavelength tracking system includes:
a wavelength encoder operable to encode the local interconnect optical channel with an optical key; and
a plurality of wavelength decoders operable to decode the optical key encoded in the local interconnect optical channel to track a path of the local interconnect optical channel.

8. The optical node of claim 2, wherein the photonic switch module is further operable to switch one or more LH optical channels received from the at least one LH optical line to the local interconnection for transmission to the another optical node.

9. An optical node, comprising:
a first module of the optical node operable to generate a first local signal;
at least one add/drop module operable to receive the first local signal and generate a local interconnect (LI) optical channel in response to the first local signal;
a photonic switch module that receives the LI optical channel from the add/drop module and switches the LI optical channel back to the add/drop module; and
wherein the at least one add/drop module receives the LI optical channel and switches the LI optical channel for output to a second module of the optical node.

10. The optical node of claim 9, wherein the first module is located on a first shelf of a physical chassis encasing the optical node and the second module is located on a second shelf of the physical chassis.

11. The optical node of claim 9, wherein the local interconnect optical channel is in an outer local interconnect band of wavelengths.

12. The optical node of claim 9, wherein the LI optical channel has one of a plurality of variable bandwidths.

13. The optical node of claim 9, wherein the LI optical channel has a higher order modulation format, wherein the higher order modulation format has greater than 4 bits per symbol.

14. The optical node of claim 9, further comprising:
a wavelength tracking system, wherein the wavelength tracking system includes:
a wavelength encoder operable to encode the local interconnect optical channel with an optical key; and
a plurality of wavelength decoders operable to decode the optical key encoded in the local interconnect optical channel to track a path of the local interconnect optical channel.

15. The optical node of claim 9, wherein the LI optical channel is remotely reconfigurable by a network management system.

16. An optical node, comprising:
at least one add/drop module operable to receive a first local signal from a first module of the optical node and switch the first local signal to a LI optical channel;
a photonic switch module that receives the LI optical channel from the add/drop module and switches the LI optical channel over a local interconnection back to the add/drop module, wherein the photonic switch module includes a set of wavelength selective switches operably coupled to the local interconnection.

17. The optical node of claim 16, further comprising:
at least one LH optical line operably coupled to the set of wavelength selective switches in the photonic switch module.

18. The optical node of claim 17, wherein the set of wavelength selective switches includes a first n×S wavelength selective switch operable to switch one or more optical channels received from S inputs to the at least one LH optical line and to switch the LI optical channel received from one or more of the S inputs to the local interconnection.

19. The optical node of claim 18, wherein the set of wavelength selective switches includes a second n×S wavelength selective switch operable to switch the one or more LH optical channels received from the at least one LH optical line to one or more of S outputs and to switch the LI optical channel received from the local interconnection to one or more of the S outputs.

20. The optical node of claim 19, wherein the S inputs of the first n×S wavelength selective switch and the S outputs of the second n×S wavelength selective switch are operably coupled to a fiber management module for switching to the at least one add/drop module.
